(19) United States
(12) Patent Application Publication
(10) Pub. No.: US 2013/0132635 A1
(43) Pub. Date: May 23, 2013

(54) DIGITAL SIGNAL TRANSCEIVER SYSTEMS

(71) Applicant: O2Micro Inc., Santa Clara, CA (US)

(72) Inventors: Wenhua CUI, Shanghai (CN); Zhihao HU, Wuhan (CN)

(73) Assignee: O2Micro Inc., Santa Clara, CA (US)

(21) Appl. No.: 13/653,987

(22) Filed: Oct. 17, 2012

(30) Foreign Application Priority Data
Nov. 17, 2011 (CN) 201110364854.4

(51) Int. Cl. G06F 13/36

(52) U.S. Cl. 710/310

(57) ABSTRACT

A system includes a first digital signal transceiver having a first interface, a second digital signal transceiver having a second interface, and a communication bus coupled between the first interface and the second interface. The communication bus is operable for establishing communication between the first digital signal transceiver and the second digital signal transceiver, and the communication is serial and asynchronous.

### RELATED APPLICATION

The present application claims priority to Patent Application No. 201110364854.4, filed on Nov. 17, 2011, with the State Intellectual Property Office of the People's Republic of China.

### BACKGROUND

With the rapid development of electric vehicle (EV) technology, there is an increasing need to improve cooperation between a charger and an EV. FIG. 1 shows a block diagram of a conventional EV system 100. As shown in FIG. 1, an EV 10 includes a battery pack 12 and a battery management system (BMS) 15. A charger 11 is used to charge the battery pack 12. The charger 11 is coupled to the battery pack 12 via a plug 13 and a socket 14.

If there is a digital signal communication channel for transferring digital signals between the charger 11 and the BMS 15, the digital signals related to statuses, e.g., a voltage or temperature, of the battery pack 12 can be transferred between the charger 11 and the BMS 15. A battery pack management device, e.g., the BMS 15 or a controller, can manage the battery pack 12 based on the transferred digital signals in an intelligent manner, so as to extend the usage life of the battery pack 12.

In order to establish a digital signal communication channel between the BMS 15 and the charger 11, extra communication interfaces can be added to the conventional EV system 100. However, this method is expensive to implement. Thus, there is a need for a method for establishing a digital signal communication channel between a battery management system and a charger that reduces cost.

A universal asynchronous receiver/transmitter (UART) can achieve full-duplex transmission and reception using an UART standard. Thus, the UART can be used in two-way asynchronous communication. In the embedded design field, the UART can communicate with a computer, e.g., a monitor debugger or other devices.

### SUMMARY

In one embodiment, a system includes a first digital signal transceiver having a first interface, a second digital signal transceiver having a second interface, and a communication bus coupled between the first interface and the second interface. The communication bus is operable for establishing communication between the first digital signal transceiver and the second digital signal transceiver, and the communication is serial and asynchronous.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a block diagram of a conventional EV system.

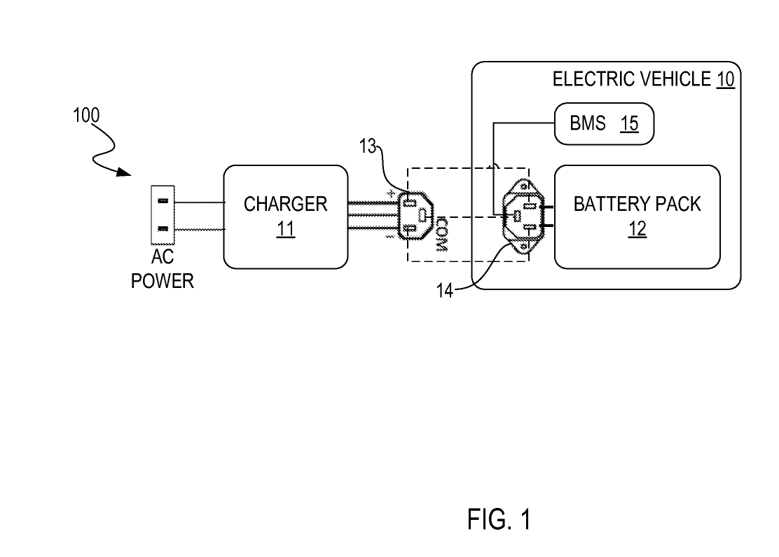

FIG. 2 shows a block diagram of an example of a digital signal transceiver system in an embodiment according to the present invention.

FIG. 3 shows a block diagram of an example of a data frame for a UART interface applied in a digital signal transceiver system in an embodiment according to the present invention.

FIG. 4 shows a format of an example of payload in a data frame for a UART interface applied in a digital signal transceiver system in an embodiment according to the present invention.

FIG. 5 shows an example of a flowchart for receiving data via a UART interface of a digital signal transceiver system in an embodiment according to the present invention.

FIG. 6 shows an example of a flowchart for reading data via a UART interface of a digital signal transceiver system in an embodiment according to the present invention.

FIG. 7 shows an example of a flowchart for transmitting data via a UART interface of a digital signal transceiver system in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

In one embodiment, the present invention provides a digital signal transceiver system that transfers digital signals in a single-wire asynchronous serial manner between a charger and a BMS based on a UART standard. Thus, the digital signals can be transferred between the charger and the BMS via a single communication bus. Existing hardware in an EV system can include a 3-prong alternating current (AC) receptacle having three sockets. In embodiments according to the present invention, two sockets of the 3-prong AC receptacle are used to charge the EV system, and the third socket of the 3-prong AC receptacle, which is idle in the conventional EV system, can be used to establish a communication channel between the BMS and the charger. As a result, the signal transfer between the BMS and the charger can be implemented less expensively.

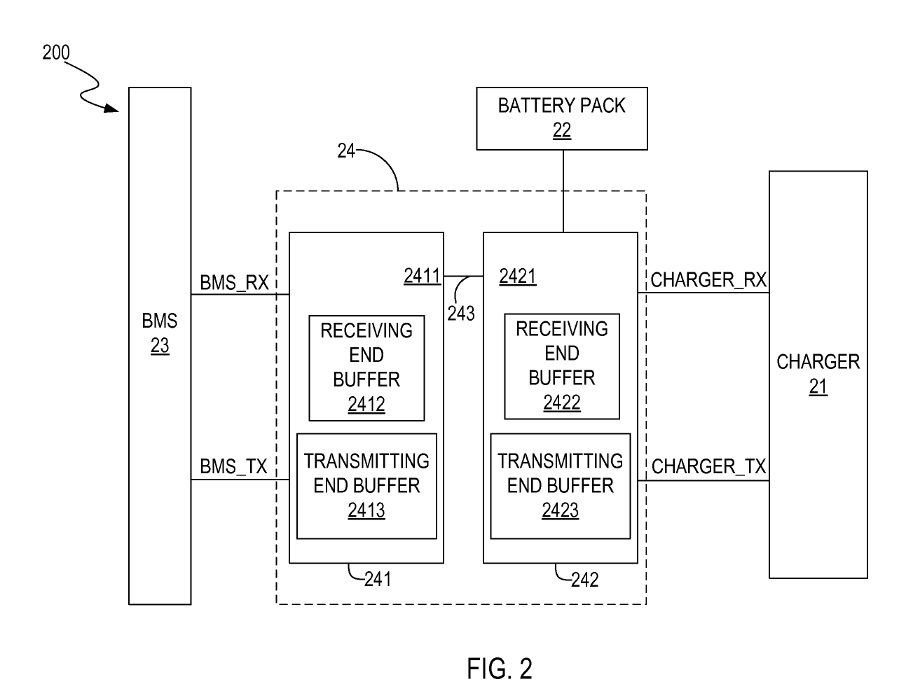

FIG. 2 shows a block diagram of an example of a digital signal transceiver system 200 in an embodiment according to the present invention. The digital signal transceiver system 200 includes a BMS 23, a digital signal transceiver device 24, a charger 21, and a battery pack 22. The digital signal transceiver device 24 includes a first digital signal transceiver 241, a second digital signal transceiver 242, and a communication bus 243. The first digital signal transceiver 241 includes a receiving end buffer 2412 for receiving data, and a transmitting end buffer 2413 for transmitting data. The second digital signal transceiver 242 includes a receiving end buffer 2422 for receiving data, and a transmitting end buffer 2423 for transmitting data. The receiving end buffer 2412 and the transmitting end buffer 2413 meet a UART standard. The receiving end buffer 2422 and the transmitting end buffer 2423 also meet the UART standard. As shown in FIG. 2, the BMS 23 is coupled to the first digital signal transceiver 241, and the charger 21 is coupled to the second digital signal transceiver 242. The first digital signal transceiver 241 has an interface 2411 that meets the UART standard (hereinafter, UART interface 2411), and the second digital signal transceiver 242 has an interface 2421 that also meets the UART standard (hereinafter, UART interface 2421). Two terminals of the communication bus 243 are coupled to the UART interfaces 2411 and 2421, respectively. The first digital signal transceiver 241 communicates with the second digital signal transceiver 242 through the UART interfaces 2411 and 2421 via the communication bus 243 in a single-wire asynchronous serial manner.

In one embodiment, a high voltage bus is used as the communication bus 243 between the charger 21 and the BMS 23. The voltage of the high voltage bus is supplied by the battery pack 22, or supplied by a voltage divider that divides the voltage of the battery pack 22. In other words, the communication bus 243 is a data transmission bus that supports a high voltage. In one embodiment, the high voltage can be the voltage of the battery pack 22, or it can be a voltage obtained by dividing the voltage of the battery pack 22 using a voltage divider. In another embodiment, the high voltage is supplied by an external device, e.g., a pull-up resistor for a charging process.

In one embodiment, the charger 21, the battery pack 22, and the BMS 23 share the high voltage bus, e.g., the communication bus 243, and therefore the charger 21, the battery pack 22, and the BMS 23 can share the same ground GND to ensure consistency of communication voltage levels of the charger 21 and the BMS 23, and ensure the possibility of the communication. Therefore, transceiver integrated circuits of the battery pack 22 and the BMS 23 can transmit and receive data via the communication bus 243.

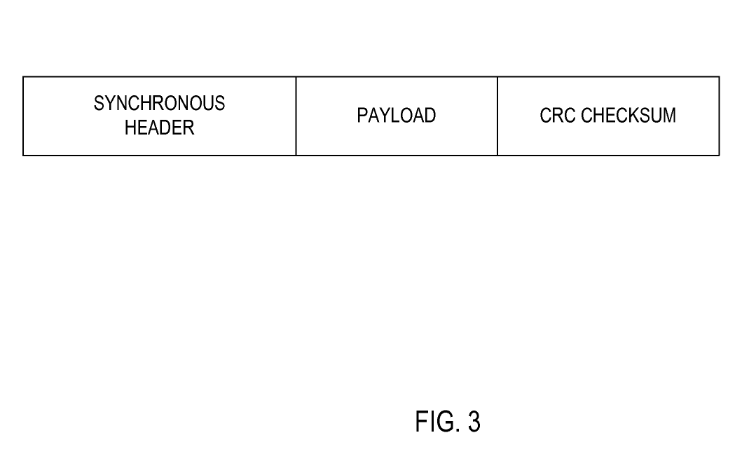

FIG. 3 shows a block diagram of an example of a data frame for a UART interface applied in the digital signal transceiver system 200 in FIG. 2 in an embodiment according to the present invention. The data frame includes a synchronous header, payload, and a cyclic redundancy check (CRC) checksum.

A receiver synchronizes with a transmitter by the synchronous header. In one embodiment, the synchronous header is set to be a data string including, e.g., five consecutive hex numbers such as “5A 5A 5A 5A 5A”. When the receiver receives the data string, the transmitter resets its state machine and assumes the following data is the payload. If the payload includes five consecutive hex numbers “5A” to be transmitted, an escape character, e.g., “0D”, is inserted into the fourth position of the data string. As such, the data string becomes “5A 5A 5A 5A 0D 5A”. When the receiver receives the above data string, the receiver ignores the escape character “0D” and restores the data string to “5A 5A 5A 5A 5A”. If load data used as an escape character appears in the payload, the escape character 0D is inserted before each load data. By way of example, if the load data transmitted by a user is “0D 0D 0D”, then the actual transmitted data is “0D 0D 0D 0D 0D D”.

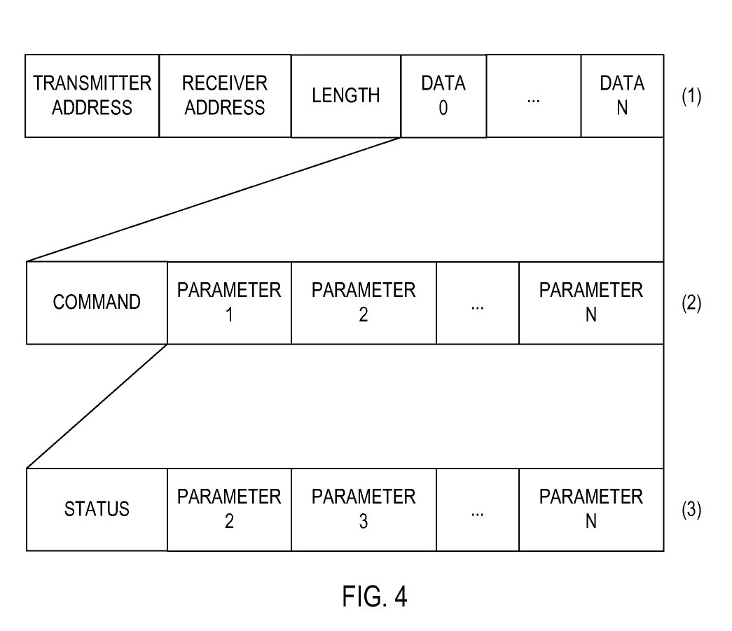

The payload includes user data to be transmitted. FIG. 4 shows a format of an example of the payload of the data frame for the UART interface applied in the digital signal transceiver system 200 in FIG. 2 in an embodiment according to the present invention. At (1), FIG. 4 illustrates a format of an example of the payload of the data frame processed by the UART interface of the digital signal transceiver system 200 in FIG. 2 according to the present invention. The TRANSMITTER ADDRESS and RECEIVER ADDRESS in the payload are used to identify a transmitter that transmits the data frame and a receiver that receives the data frame. Table 1 illustrates a mapping relationship between an address and a device in an EV system.

TABLE 1

| Address | Module | Comments |
|---|---|---|
| 0x00 | — | Broadcast Address, Reserved |
| 0x01 | BMS | BMS Address |
| 0x02 | Charger | Charger Address |
| . . . | — | Reserved For Extension |
| 0x81 | PC Utility | PC Utility |
| . . . | — | Reserved |

The LENGTH in the payload represents the byte number of the following data. If there is no data, the LENGTH is zero. In one embodiment, the maximum value of LENGTH is 60 (a decimal number).

In the example at (2) of FIG. 4, the DATA 0 at (1) is set as COMMAND data, and the DATAs 1-N at (1) are set as PARAMETERs 1-N, respectively. The DATA 0 at (1) represents a command from the transmitter, and the DATAs 1-N at (1) represent parameters related to the command, and therefore FIG. 4 at (2) illustrates command and command parameters in the payload.

In one embodiment, commands in the data frames are classified according to Table 2 shown below.

TABLE 2

| Command | | | |
|---|---|---|---|
| range | Command | Function | Module |
| 0x10-0x1F | 0x10-0x1F | Boot Loader | Boot Loader |
| 0x20-0x7F | 0x20-0x3F | Parameter/Lookup | Utility<->BMS |
| | | Table | |
| | 0x40-0x4F | Calibration | Utility<->BMS |
| | 0x50-0x5F | Debug Interface | Utility<->BMS |
| | 0x60-0x6F | BMS Register | Utility<->BMS |
| | | Monitor | |
| | 0x70-0x77 | Log Export | Utility<->BMS |
| | 0x78-0x7F | I2C Adapter | Utility<->BMS |
| 0x80-0x9F | 0x80-0x8F | Reserved | |
| | 0x90-0x9F | BMS Address | Charger<->BMS |
| | | Allocation | |
| | 0xA0-0xBF | Reserved | |

In the example at (3) of FIG. 4, the PARAMETER 1 at (2) is set as STATUS. When receiving a command, the receiver can execute the command and reply to the transmitter that transmits the command. As to the broadcast command, the receiver does not need to reply. The first byte after the command, e.g., PARAMETER 1, represents an execution status of the command as shown in Table 3.

TABLE 3

| Code | Meaning |
|---|---|
| 0x00 | Command is executed successfully |
| 0x01 | Device is busy |
| 0x02 | Invalid parameters |
| 0x03 | Unknown command |
| 0x04 | Access denied |

Referring to FIG. 3, the CRC CHECKSUM includes a checksum of all the data, e.g. including address data, length data, command data, etc, in the payload. In one embodiment, CRC CHECKSUM is an 8-digit checksum obtained by a polynomial X⁸+X²+X+1.

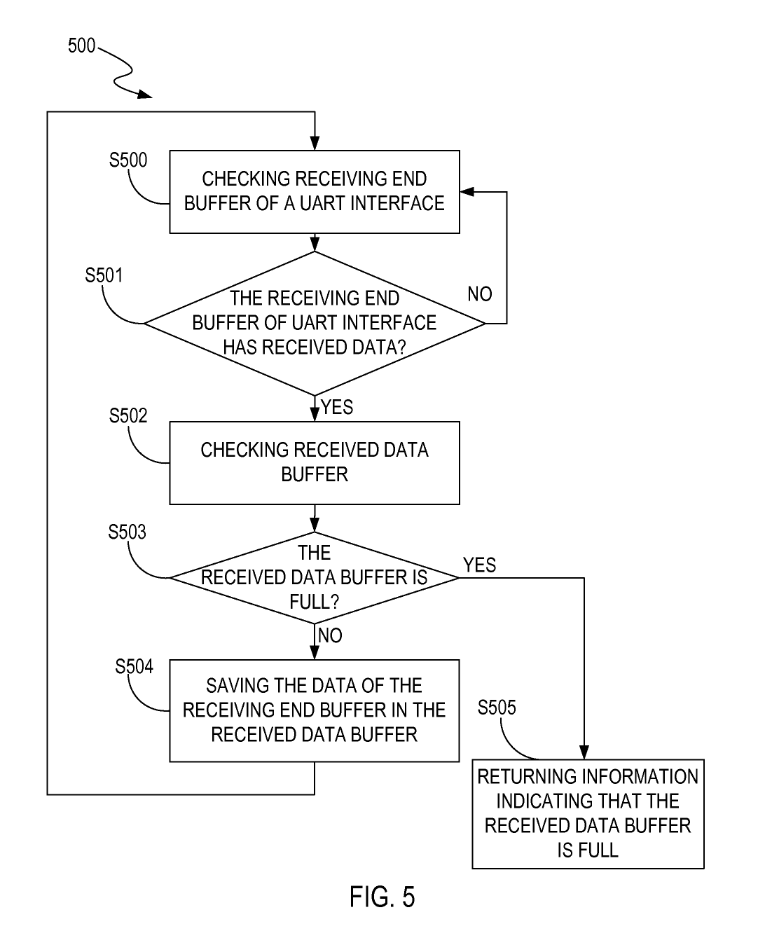

FIG. 5 shows an example of a flowchart 500 for receiving data via the UART interface of the digital signal transceiver system 200 in FIG. 2 in an embodiment according to the present invention. Although specific steps are disclosed in FIG. 5, such steps are examples. That is, the present invention is well suited to performing various other steps or variations of the steps recited in FIG. 5. In one embodiment, the first digital signal transceiver 241 and/or the second digital signal transceiver 242 can receive a predetermined length of data, e.g., a byte of a data, by performing the following steps.

In step S500, a digital signal transceiver, e.g., the first digital signal transceiver 241, or the second digital signal transceiver 242, used as a receiver, checks a receiving end buffer, e.g., the receiving end buffer 2412, or the receiving end buffer 2422, of a UART interface of the digital signal transceiver.

In step S501, the receiver detects whether the receiving end buffer has received a predetermined length of data, e.g., a byte of a data. If the receiving end buffer has received the predetermined length of data, then the flowchart turns to step S502; otherwise, it turns to step S500.

In step S502, the receiver checks a received data buffer of the digital signal transceiver.

In step S503, the receiver detects whether the received data buffer is full. If the received data buffer is full, then the flowchart turns to step S505; otherwise, it turns to step S504.

In step S504, the receiver saves data of the receiving end buffer of the UART interface in the received data buffer. The flowchart returns to step S500 and conducts data receiving for a next byte.

In step S505, the receiver returns information indicating that the received data buffer is full.

According to step S504 shown in FIG. 5, the first digital signal transceiver 241 and the second digital signal transceiver 242 can respectively receive data via receiving end buffers of corresponding UART interfaces. The received data is further saved in a corresponding received data buffer. During the data transmission process, a complete transmission is finished only when the first digital signal transceiver 241 and the second digital signal transceiver 242 have read data from their corresponding received data buffers.

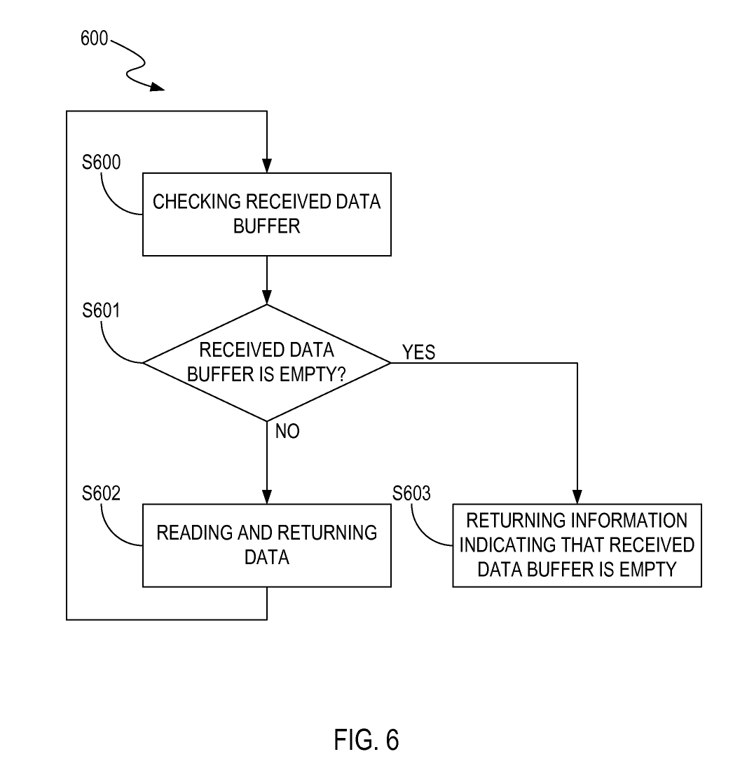

FIG. 6 shows an example of a flowchart for reading data via the UART interface of the digital signal transceiver system 200 in FIG. 2 in an embodiment according to the present invention. Although specific steps are disclosed in FIG. 6, such steps are examples. That is, the present invention is well suited to performing various other steps or variations of the steps recited in FIG. 6. In one embodiment, the first digital signal transceiver 241 and the second digital signal transceiver 242 read data from their corresponding received data buffers by performing the following steps.

In step S600, the receiver checks the received data buffer.

In step S601, the receiver detects whether the received data buffer is empty. If the received data buffer is empty, then the flowchart turns to step S603; otherwise, it turns to step S602.

In step S602, the receiver reads data of the received data buffer and returns the data. The flowchart returns to step S600.

In step S603, the receiver returns information indicating that the received data buffer is empty.

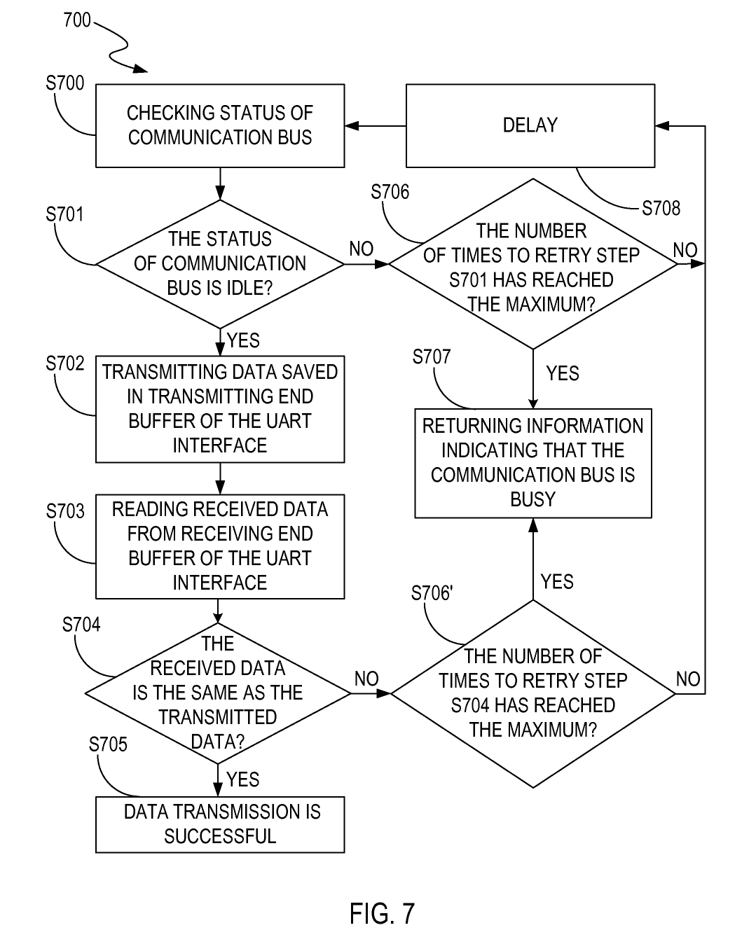

Since the present invention utilizes a UART interface to conduct single-wire asynchronous serial communication, the first digital signal transceiver 241 and the second digital signal transceiver 242 need to avoid transmission conflict when transmit data. FIG. 7 shows of an example of a flowchart for transmitting data via the UART interface of the digital signal transceiver system 200 in FIG. 2 in an embodiment according to the present invention. Although specific steps are disclosed in FIG. 7, such steps are examples. That is, the present invention is well suited to performing various other steps or variations of the steps recited in FIG. 7.

According to the example of FIG. 7, the transmitting end buffer 2412 of the UART interface of the first digital signal transceiver 241 can transmit data to the receiving end buffer 2422 of the UART interface of the second digital signal transceiver 242. Similarly, the transmitting end buffer 2423 of the UART interface of the second digital signal transceiver 242 can transmit data to the receiving end buffer 2413 of the UART interface of the first digital signal transceiver 241. Since the first digital signal transceiver 241 and the second digital signal transceiver 242 use the same communication bus 243 to transmit and receive data, the receiving end buffers of the UART interfaces of the first digital signal transceiver 241 and the second digital signal transceiver 242 can receive the same data if the transmission is successful. Based on the above mentioned principle, the first digital signal transceiver 241 and the second digital signal transceiver 242 respectively read data according to the method mentioned in FIG. 6. Thus, by comparing the transmitted data with the received data, the first digital signal transceiver 241 and the second digital signal transceiver 242 respectively determine whether the transmission is successful. If the transmitted data is the same as the received data, then the transmitting end buffer of the UART interface successfully transmits the transmitted data. Advantageously, the transmission process according to the present invention can effectively avoid transmission conflict.

In step S700, a digital signal transceiver, e.g., the first digital signal transceiver 241, or the second digital signal transceiver 242, used as a transmitter, checks a status of the communication bus 243.

In step S701, the transmitter detects whether the status of the communication bus 243 is idle. If the status is idle, then the flowchart turns to step S702; otherwise, it turns to S706.

In step S702, the transmitter transmits data saved in the transmitting end buffer of the UART interface via the communication bus 243. More specifically, the digital signal transceiver writes the data from a transmitted data buffer into the transmitting end buffer of the UART interface and transmits the data to the receiver via the communication bus 243. The flowchart turns to step S703.

In step S703, the transmitter reads data from the transmitting end buffer of the UART interface. More specifically, when the transmitter transmits data via the communication bus 243, the receiving end buffer of the UART interface of the transmitter receives the data from the transmitting end buffer of the UART interface of the transmitter via the communication bus 243. The transmitter reads the data from the receiving end buffer of the UART interface and returns the data in a way as described in FIG. 5 and FIG. 6.

In step S704, the transmitter detects whether the data transmission is successful. If the data transmission is successful, then the flowchart turns to S705; otherwise, it turns to S706′. More specifically, the transmitter checks whether the data of the receiving end buffer of the UART interface is the same as the data of the transmitting end buffer of the UART interface. If they are the same, the data transmission is successful; otherwise, it fails.

In step S705, the transmitter returns information indicating that the data transmission is successful.

In step S706, the transmitter detects whether the number of times to retry the step S701, e.g., determining the status of the communication bus, has reached a predetermined maximum number. If the number of times to retry the step S701 has reached the maximum number, the flowchart turns to step S707; otherwise, it turns to step S708.

In step S706′, the transmitter checks whether the number of times to retry the step S704, e.g., determining whether the received data is the same as the transmitted data, has reached a predetermined maximum number. If the number of times to retry the step S704 has reached the maximum number, the flowchart turns to step S707; otherwise, it turns to step S708.

In step S707, the transmitter returns information indicating that the communication bus is busy.

In step S708, the transmitter delays for a predefined time, and then performs step S700 to retry the transmission of the data.

Thus, according to one embodiment of the present invention, a battery management system in an EV is coupled to the aforementioned first digital signal transceiver. However, the invention is not so limited. Other controlling devices, e.g., including a controller, in the EV can also be coupled to the first digital signal transceiver. Additionally, a digital signal transceiver system according to the present invention can be applied to an EV charging process, and also can be applied to other applications, e.g., including a battery detecting process. Therefore, other external digital signal processing devices, e.g., including a monitor (display device) for the EV, can also be coupled to the second digital signal transceiver.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A system comprising:
a first digital signal transceiver having a first interface;
a second digital signal transceiver having a second interface; and
a communication bus, coupled between said first interface and said second interface, operable for establishing communication between said first digital signal transceiver and said second digital signal transceiver, wherein said communication is serial and asynchronous.

2. The system as claimed in claim 1, wherein said first digital signal transceiver further has a receiving end buffer for receiving data and a transmitting end buffer for transmitting data.

3. The system as claimed in claim 2, wherein said first interface, said receiving end buffer, and said transmitting end buffer meet a universal asynchronous receiver/transmitter (UART) standard.

4. The system as claimed in claim 1, wherein said second digital signal transceiver further has a receiving end buffer for receiving data and a transmitting end buffer for transmitting data.

5. The system as claimed in claim 4, wherein said second interface, said receiving end buffer, and said transmitting end buffer meet a UART standard.

6. The system as claimed in claim 1, wherein said first digital signal transceiver further has a received data buffer for storing received data, and said second digital signal transceiver further has a received data buffer for storing received data.

7. A system comprising:
a first digital signal transceiver having a first interface;
a second digital signal transceiver having a second interface;
a communication bus coupled between said first and second interfaces;
a first digital signal processing device coupled to said first digital signal transceiver; and
a second digital signal processing device coupled to said second digital signal transceiver,
wherein said first interface is coupled to said second interface via said communication bus, and wherein said communication bus establishes communication between said first digital signal processing device and said second digital signal processing device, wherein said communication is serial and asynchronous.

8. The system as claimed in claim 7, wherein said first interface and said second interface meet a UART standard.

9. The system as claimed in claim 7, wherein said first digital signal processing device comprises a battery management system.

10. The system as claimed in claim 7, wherein said first digital signal processing device comprises a controller.

11. The system as claimed in claim 7, wherein said second digital signal processing device comprises a battery charger.

12. The system as claimed in claim 7, wherein said second digital signal processing device comprises a monitor.

13. A method for receiving a digital signal using a system comprising: a first digital signal transceiver having a first interface and a first receiving end buffer; a second digital signal transceiver having a second interface and a second receiving end buffer; and a communication bus coupled between said first and second interfaces, wherein a transceiver of said first and second digital signal transceivers is used as a receiver, and wherein said method comprises:
establishing communication between said first digital signal transceiver and said second digital signal transceiver, wherein said communication is serial and asynchronous;
detecting whether a receiving end buffer of said receiver has received a predetermined length of data; and
transferring said predetermined length of data to a received data buffer of said receiver if said receiving end buffer has received said predetermined length of data.

14. The method as claimed in claim 13, wherein said first interface, said first receiving end buffer, said second interface, and said second receiving end buffer meet a UART standard.

15. The method as claimed in claim 13, wherein said first digital transceiver further comprises a first received data buffer and said second digital transceiver further comprises a second received data buffer, wherein said method further comprises:
detecting whether said received data buffer of said receiver is full;
saving said predetermined length of data of said receiving end buffer in said received data buffer if said received data buffer is not full; and
returning information indicating that said received data buffer is full.

16. The digital signal receiving method as claimed in claim 15, further comprising:
detecting whether said received data buffer of said receiver is empty;
reading the data saved in said received data buffer and returning said data if said received data buffer is not empty; and
returning information indicating that said received data buffer is empty if said received data buffer is empty.

17. A method for transmitting a digital signal using a system comprising: a first digital signal transceiver having a first interface, a first receiving end buffer, and a first transmitting end buffer; a second digital signal transceiver having a second interface, a second receiving end buffer, and a second transmitting end buffer; and a communication bus coupled between said first and second interfaces, wherein a transceiver of said first and second digital signal transceivers is used as a transmitter, and wherein said method comprises:
establishing communication between said first digital signal transceiver and said second digital signal transceiver, wherein said communication is serial and asynchronous;
checking a status of said communication bus using said transmitter;
returning information indicating that said communication bus is busy if said status is busy;
transmitting data from a transmitting end buffer of said transmitter to a transceiver used as a receiver via said communication bus if said status is idle;
receiving data using a receiving end buffer of said receiver via said communication bus;
checking whether the received data is the same as the transmitted data;
returning information indicating that the data transmission is successful if said received data is the same as said transmitted data.

18. The method as claimed in claim 17, wherein said first interface, said first receiving end buffer, said first transmitting end buffer, said second interface, said second receiving end buffer, and said second transmitting end buffer meet a UART standard.

19. The method as claimed in claim 18, wherein said first digital signal transceiver further comprises a first received data buffer, and said second digital signal transceiver further comprises a second received data buffer.
